(19) United States
(12) Patent Application Publication
(10) Pub. No.: US 2007/0199209 A1
(43) Pub. Date: Aug. 30, 2007

(54) Shoe with an integrated storage module

(76) Inventors: Jennifer Schreck, Chicago, IL (US); Jeanne Drogosz, Chicago, IL (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/654,200

(22) Filed: Jan. 17, 2007

Related U.S. Application Data
(60) Provisional application No. 60/759,339, filed on Jan. 17, 2006.

(51) Int. Cl. A43B 3/12; G06F 3/00

(52) U.S. Cl. 36/11.5; 708/132

(57) ABSTRACT

The present invention relates to shoes that include a cavity that is configured to store a variety of different types of items. For example, in one embodiment, the cavity is configured to accept the removable insertion of a storage module that may contain a variety of items, for example children books and/or toys. In other embodiments, items may be stored inside the cavity without the use of the storage module. The storage module may also be secured within the cavity of the shoe through the use of a variety of fasteners. The storage module may be an integral part of the shoe, or may be separate part of the shoe. Further, the storage module may be connected to the shoe through the use of a strap.

### RELATED APPLICATIONS

This application claims the benefit of U.S. Provisional Application No. 60/759,339, filed Jan. 17, 2006.

### BACKGROUND OF THE INVENTION

Combining something fun and something educational is an every day challenge for parents of developing children. Parents are often searching for ways to entertain or occupy their children. However, unless planned otherwise, often the toys or other items, for example books, used to entertain or occupy the child are at one location, often the home the child lives in. However, there are times, whether expected or unexpected, where the parent and/or child wishes it had with them a toy or item so as to occupy the child.

But transporting such items often requires that the item be stowed in either a pocket of a garment, namely the pocket of a shirt, pants, or jacket, be carried in a bag, for example a backpack or purse, or carried by hand. But sometimes none of these options are desirable. For instance, the size of the pocket may be inappropriate for the item to be stored and/or carried. Further, without proper protection, an item carried in a pocket may become damaged. Additionally, carrying the item in the garment may make the garment uncomfortable to wear. And carrying the item in a bag or by hand may not only be unduly burdensome, but may also increase the possibility that the item may be misplaced or inconveniently left behind at another location, such as being forgotten in the car.

Adults often have the same concerns when deciding how to carry with them a variety of different items, for example personal identification, keys, cash, and credit cards. Adults may also have the additional concern that, in some situations, for personal safety or fashion reasons, storing personal items in a garment or carrying a bag(s) may be undesirable.

Therefore a need exists for a convenient way of carrying and/or storing items without the burden of having to carry the items by hand or in a bag, and which does not require stowing the item in a garment.

### BRIEF SUMMARY OF THE INVENTION

In one embodiment, the apparatus of the present invention is a shoe that may include a cavity that is configured to receive the insertion of a storage module. The cavity may be positioned at various locations along the shoe. For instance, the cavity may be located at the rear, side, front, top, bottom, or heel of the sole or underside of the shoe. The cavity may also be at least partially covered by a flap or door that may be removed, slid, or pivoted away from or into the cavity.

The storage module may be designed so that at least a portion of the storage module has a snug fit within the cavity so that the storage module remains securely positioned within the cavity. Alternatively, the storage module may also be secured to the shoe through the use of various types of fasteners, including extension tabs, knobs, hook and loop material, adhesives, latches, snaps, ties, buttons, pins, doors, caps, tabs, knobs, magnets, and straps, among others. In such an embodiment, the storage module may be a separate component that may be completely separated from the shoe. Additionally, the storage module and cavity may be configured to cooperatively allow all, or only a portion, of the storage module to move into and out of the cavity. In another embodiment, the storage module and cavity may be a fixed integrated part of the sole or the shoe. Further, the storage cavity may be operatively connected to the shoe, such as by a rope, string, strap, or cord, among others. Such an embodiment may assist in the unintentional separation of the storage module from the shoe.

The storage module may be constructed from a variety of different materials, including plastic, aluminum, tin, nylon, denim, and cloth, among others. In one embodiment, the storage module may have a lid portion, a bottom portion, and at least one inner region that is configured to store various items. For instance, the inner region may be configured to store reading materials, notes, pictures, toys, identification, money, credit cards, and cellular phones, among others. The lid portion and bottom portion of the storage module may be configured to protect the items stored within the storage module. The storage module may also be configured to assist in the ability to the shoe to provide support to the foot of the individual.

In one embodiment, the lid portion may be removed from the rest of the storage module so that the storage module is open. The lid portion may then be placed back onto the storage module so that the storage module may be closed. In another embodiment, the lid portion may be pivotably connected to at least a portion of the storage module so as to allow the lid portion to pivot the storage module from a closed to an opened position, and conversely from an opened position to a closed position.

In another embodiment, the storage module may be a bag. Than bag may include elements for closing the bag, such as snaps, buttons, hook and loop material, or a drawstring, among others. The storage module may also be configured with a specific shape that allows the storage module to mate with the shape of the cavity in the shoe. For example, the storage module may have a rectangular, square, cylindrical, spherical, bowed, heart-shaped, or wave configuration, among others, as would be appreciated by one of ordinary skill in the art, that may allow at least a portion of the storage module to fit inside the cavity of the shoe.

The configuration of the storage module may also be tailored for the individual user and/or the style of the associated shoe. For instance, for children, the storage module may be configured to accept the removable insertion of miniature books, identification materials, toys, and keys, among other things. For adults, the compartment may be used for storing a number of different items, including, but not limited to, money, credit cards, identification, cellular phones, beverages, and keys. Moreover, the type of shoe may also influence the shape and/or size of the cavity. For instance, for athletic shoes, the cavity and any associated storage module may be configured for specific items, such as, but not limited to, keys and money. Dress shoes may have compartments specific for items such as credit cards, among other things. Further, matching right shoes and left shoes may have shaped cavities, a different number of cavities, and/or cavities located in different positions. Further, only one shoe may have a cavity and/or storage module.

In another embodiment of the present invention, the use of a storage module may be unnecessary. For instance, the cavity may be configured to sufficiently retain the item to be stored in the cavity. The storage module may include a door, cap, or strap, among others, that may assist in retaining the stored material or item within the cavity. The cavity may also include a clamp or other securing mechanisms that may be biased or configured to hold the item to be stored within the cavity.

### BRIEF DESCRIPTION OF SEVERAL VIEWS OF THE DRAWINGS

FIG. 1 illustrates a perspective view of a right and left shoe both having cavities in the heel of the shoes that are configured to accept the removable insertion of a separate storage module or other items according to one embodiment of the present invention.

FIG. 2 illustrates a shoe having a cavity that is covered by a removable or pivotable flap that may be manipulated so as to cover or open the cavity according to one embodiment of the present invention.

FIG. 3a illustrates a perspective view of a storage module according to one embodiment of the present invention.

FIG. 3b illustrates a side view of a storage module according to one embodiment of the present invention.

FIG. 3c illustrates a top view of a storage module according to one embodiment of the present invention.

FIG. 4 illustrates a side profile of a shoe having a cavity configured for the removable insertion of a storage module according to one embodiment of the present invention.

FIG. 5 illustrates a perspective view of a shoe having multiple cavities configured to receive the removable insertion of multiple storage modules according to one embodiment of the present invention.

FIG. 6 illustrates a perspective view of a shoe having a cavity in the heel of the shoe according to one embodiment of the present invention.

FIG. 7a illustrates a perspective view of a shoe having back tabs that mate with protrusions on a storage module according to one embodiment of the present invention.

FIG. 7b illustrates a side view of a shoe having back tabs that mate with protrusions on a storage module according to one embodiment of the present invention.

FIG. 7c illustrates a top view of a shoe having back tabs that mate with protrusions on a storage module according to one embodiment of the present invention.

FIG. 8a illustrates a perspective view of a shoe having a plug insert that may assist in securing at least a portion of a storage module within the cavity according to one embodiment of the present invention.

FIG. 8b illustrates a top view of a shoe having a plug insert that may assist in securing at least a portion of a storage module within the cavity according to one embodiment of the present invention.

FIG. 8c illustrates a side view of a shoe having a plug insert that may assist in securing at least a portion of a storage module within the cavity according to one embodiment of the present invention.

FIG. 9a illustrates a side view of a storage module configured to mate with a plug insert according to one embodiment of the present invention.

FIG. 9b illustrates a bottom view of a storage module configured to mate with a plug insert according to one embodiment of the present invention.

FIG. 10 illustrates a partial cross-sectional side view of the use of a magnetic connection to secure a storage module within the cavity of a shoe according to one embodiment of the present invention.

FIG. 11a illustrates a perspective view of the bottom of a shoe having a plug insert configured to assist in retaining a storage module in the cavity of a shoe according to one embodiment of the present invention

FIG. 11b illustrates a side view of a shoe having a plug insert configured to assist in retaining a storage module in the cavity of a shoe according to one embodiment of the present invention.

FIGS. 11c, 11d, and 11e illustrate the interaction between a plug insert and a storage module according to embodiments of the present invention.

FIG. 12 illustrates a perspective view of a storage module secured inside the cavity of a shoe through the use of at least one protrusion on the storage module interlocking with a mating aperture in the shoe according to one embodiment of the present invention.

FIG. 13a illustrates a side view of a storage module secured inside the cavity of a shoe through the use of attachment straps on the storage module interlocking with the shoe according to one embodiment of the present invention.

FIG. 13b illustrates a top view of a storage module secured inside the cavity of a shoe through the use of attachment straps on the storage module interlocking with the shoe according to one embodiment of the present invention.

FIG. 14 illustrates a perspective view of a storage module having a tab extension that mates with a portion of a shoe in accordance with one embodiment of the present invention.

FIG. 15 illustrates perspective view of a shoe having a first cavity, a second cavity, and a strap section including a cover, a bottom portion, and at least one page of literature there-between according to one embodiment of the present invention.

FIG. 16 illustrates a perspective view of a shoe having a hollow inner region that is configured for the removable insertion of a storage module according to one embodiment of the present invention.

FIG. 17 illustrates a top view of a shoe having at least one fastener and a sole that includes a top portion, a bottom portion, and a middle section having multiple layers that may be separated to form the pages of literature according to one embodiment of the present invention.

FIG. 18 illustrates a perspective view of a shoe in the form of a sandal having a cavity within the strap portion of the sandal according to one embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawing.

### DETAILED DESCRIPTION OF THE INVENTION

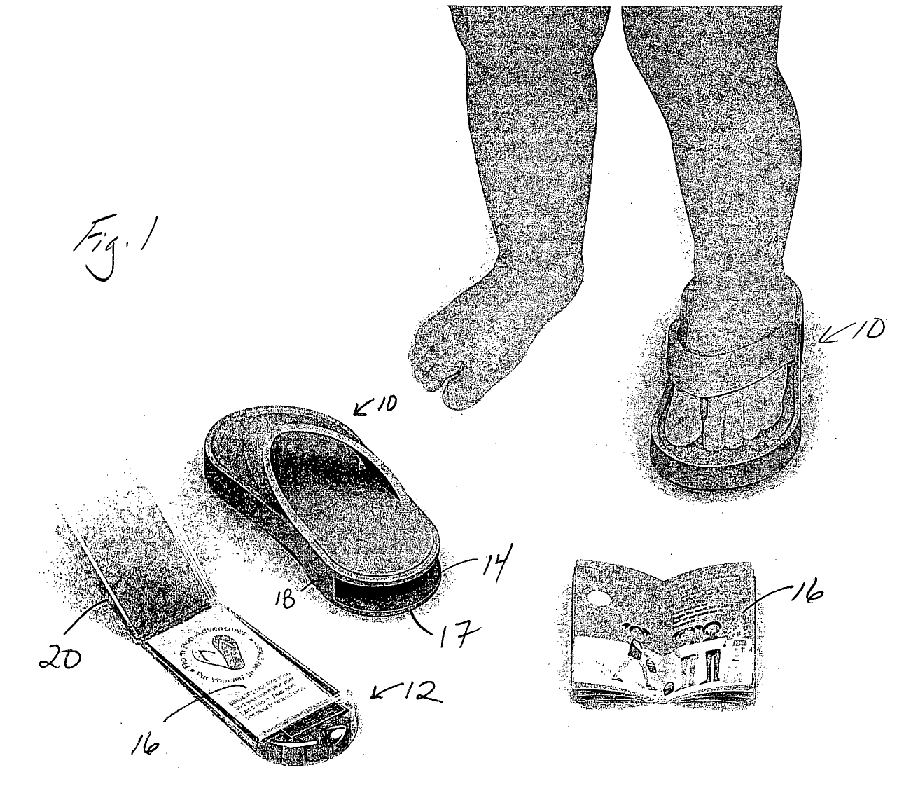

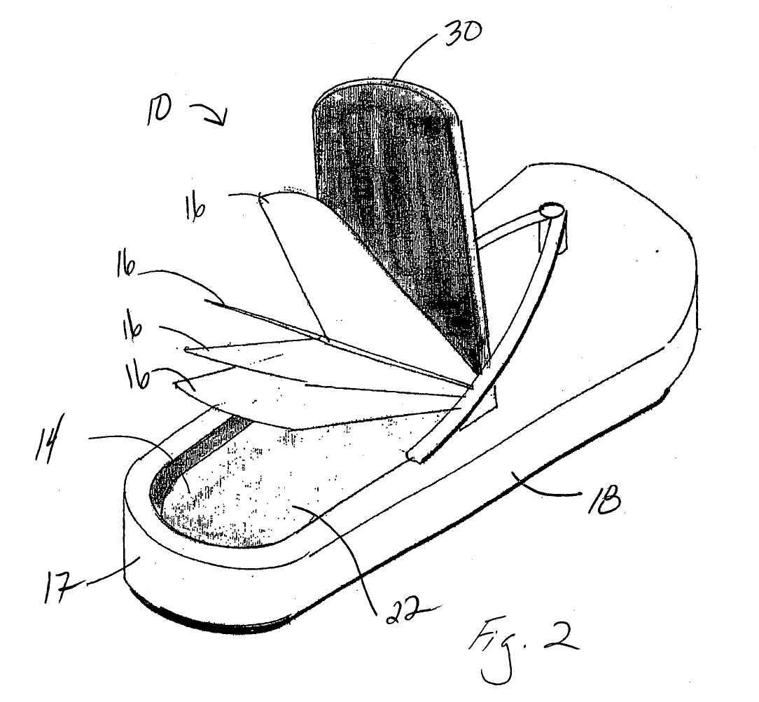

FIG. 1 illustrates a perspective view of a right and left shoe 10 both having cavities 14 in the heel 17 of the shoe that are configured to accept the removable insertion of a storage module 12 or other items according to one embodiment of the present invention. Although FIG. 1 illustrates the shoes 10 as being flip-flops, the present invention may be used with various types of other shoes 10, including sandals, boots, sneakers, running shoes, play shoes, casual shoes, and dress shoes, among others.

In the embodiment illustrated in FIG. 1, the storage module 12 may be a container, such as a box, pouch, or bag, among others. The storage module 12 may include an inner region 22 that is configured to receive the placement of different items, including reading materials 16, credit cards, keys, and personal identification, among others.

The shoe 10 may include a cavity 14 that is configured to receive the removable insertion and placement of the storage module 12 or other items within the cavity 14. The cavity 14 may be positioned at various locations along the sides or bottom of the shoe 10, including the heel 17. Although in some shoes at least a portion of the heel 17 may be a separate and distinct portion at the bottom of the shoe 10 from the sole 18, for purposes of the present invention, the heel 17 will be considered to be part of the sole 18. In the embodiment illustrated in FIG. 1, the cavity 14 is positioned in the rear side portion of the heel 17. The cavity 14 may be created in the shoe 10 through a variety of different processes, including molding, cutting, slotting, drilling, or shaping the cavity 14.

When placed within the cavity 14, the storage module 12 and/or cavity 14 may be sized so that the storage module 12 securely fits within the cavity 14 of the shoe 10, particularly while the shoe 10 is being worn and in use. Alternatively, the storage module 12 may be secured inside cavity 14 through the use of various types of fasteners or a press-fit. For example, the storage module 12 may be secured within the sole 18 through the use of hook and loop material, adhesive, latches, snaps, ties, buttons, pins, and straps, among others. Alternatively, the storage module 12 may be at least partially enclosed or secured within the shoe through the use of a door or panel that operably attaches to the shoe 10.

In an alternative embodiment, at least a portion of the storage module 12 may function similar to a drawer in that at least a portion of the storage module 12 may slide out of the cavity 14 while still being remaining operably connected to the shoe 10. Alternatively, at least a portion of the storage module 12 may be pivoted or rotated away from the shoe 10 so as to allow access to the inner region 22 of the storage module 12, while also allowing the storage module 12 to remain operably connected to the shoe 10.

The storage module 12 may be configured to be an opened container or may contain a side or lid portion that is capable of being removed. For instance, the storage module 12 may be a five-sided box, wherein the missing side, such as the topside, provides an opening through which items may be placed into, or removed from the storage module 12. In another configuration, at least a portion of a side or lid portion of the storage module 12 may be removable so as to allow access to the inner region 22 of the storage module 12. In another embodiment, a side or lid portion may be pivotably or rotatably connected to storage module 12, so that the side may be manipulated from an opened to a closed position and vice-a-versa. In one such embodiment, the side may function as a flap 20 that is operably attached to the storage module 12 though the use of a hinge, such as a living hinge. Further, the flap 20 may be configured to be biased against at least a portion of the storage module 12 so as to provide sufficient resistance to remain held in a closed position. Alternatively, the flap 20 may held in a closed position through the use of a number of fasteners, including hook and loop material, magnets, snaps, clasp, and buckles, among others.

In another embodiment, the shoe 10 may include a cavity 14 that is covered by a removable or pivotable flap 30 that may be manipulated so as to cover or open the cavity 14. In such an embodiment, the cavity 14 may or may not be configured to receive the insertion of a storage module 12.

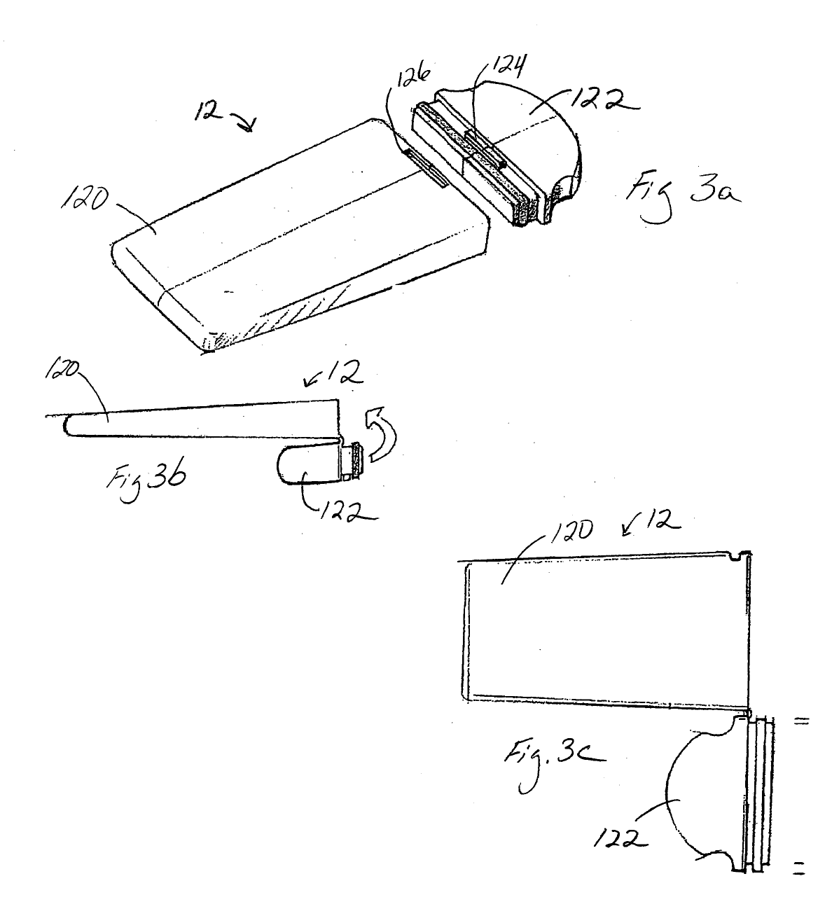

FIGS. 3a, 3b, and 3c illustrate examples of storage modules 12 that may be configured for removable insertion into the cavity 14 of a shoe 10 according to several embodiments of the present invention. As shown, the storage module 12 may be include a first section 120 and a second section 122. The second section 122 and first section 120 may be configured so that when joined together, access to the interior region is closed, and also capable of being separated from each other so that the inner region of the storage module 12 is open. The first and section sections 120, 122 may be configured for a locking engagement with each other. More particularly, the first and second sections 120, 122 may be locked together through the use of a variety of different fasteners, such as hook and loop material, snaps, buttons, tabs, knobs, and attachment straps, among others. Alternatively, as shown in FIG. 3a, the second section 122 may include a lip 124 that snaps into a recess 126 or opening in the first section 120 so as securely join the second section 122 with the first section 120.

The first and/or second sections 120, 122 may also include a seal, such as an O-ring, that assists in creating a tight closure between at least a portion of the connection between the first and second sections 120, 122, this tight closure may provide a watertight seal that protects the materials contained within the inner region of the storage module 12. For example, this seal may be configured to create a watertight connection.

As shown in FIG. 3a, in one embodiment the second section 122 may be completely separated from the first section 120. Alternatively, as shown in FIGS. 3b and 3c, when manipulated from an open to a closed position, and vice-versa, the second section 122 may pivot about at least a portion of the first section 120. Further, while FIGS. 3a, 3b, and 3c illustrate access to the inner region of the storage module 12 through the rearward section of the storage module 12, in other embodiments the first and second sections may be configured so that access to the inner region of the storage module may be through the forward, side, top, or bottom of the storage module 12. Additionally, the storage module 12 may have multiple sections that provide access to multiple compartments within the storage module 12.

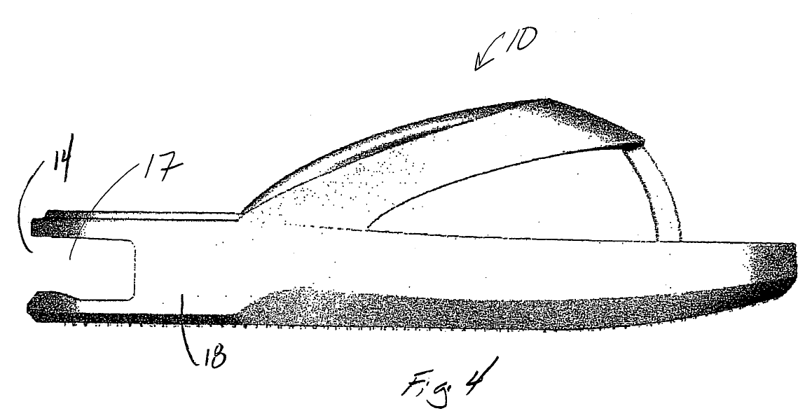

FIG. 4 illustrates a side profile of a shoe 10 having a cavity 14 configured for the removable insertion of a storage module 12 according to one embodiment of the present invention. As shown, the opening of the cavity 14 may extend along at least a portion of the heel region 17 and sides of the sole 18 of the shoe 10. As exemplified by FIG. 5, the size, position, and number of cavities 14 may be influenced by, among other things, the size, number, and configuration of the storage module(s) 12, the material of the shoe 10, and whether any attachment mechanisms are utilized to assist in retaining at least a portion of the storage module 12 within the cavity 14, as well as aesthetic considerations. But, as previously mentioned, the cavity 14 may be positioned at any number of locations on the shoe. For example, in another embodiment, the cavity 14 may have an opening at one or both sides of the shoe, such as in the sole in vicinity of the arch of the foot. Further, as also previously mentioned, the cavity may be configured to receive the removable insertion of different shaped storage modules 12 or other items, such as generally cylindrical, square, rectangular, or tapered shaped storage modules 12 or items.

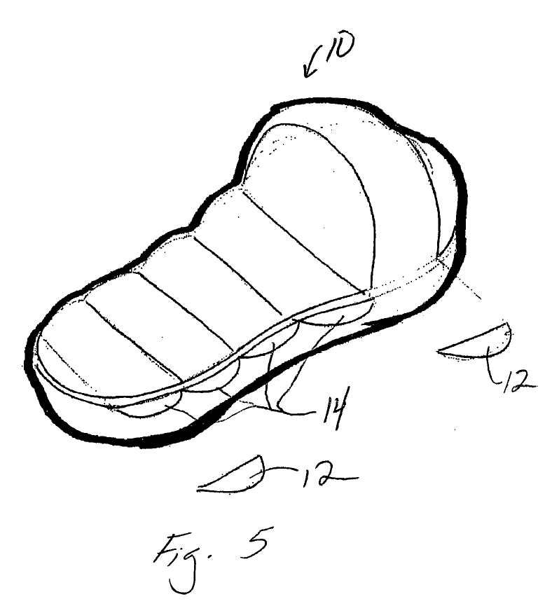

FIG. 6 illustrates a perspective view of a shoe 10 having a cavity in the heel region of the shoe 10 according to one embodiment of the present invention. As illustrated, the shoe 10 may be in the form of a sandal or flip-flop, among others. The shoe 10 may also include a plug insert 24, which, as discussed in more detail below, may serve a variety of different functions, for example, but not limited to, assisting in retaining within and/or releasing the storage module 12 from the cavity 14, covering a storage compartment, or merely providing text or images that may convey information or messages.

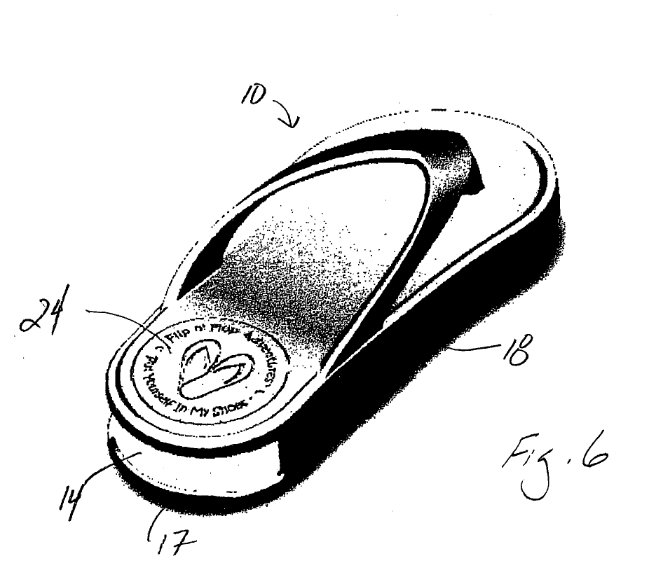

FIGS. 7a, 7b, and 7c illustrate a perspective, side, and top view, respectively, of a shoe 30 having back tabs 34 that mate with protrusions 36 on a storage module 32 according to one embodiment of the present invention. The back tabs 34 may be molded or crafted as part of the shoe 30, or may be operably connected to the shoe, such as through the use of stitching, adhesives, tacks, snaps, or buttons, among others. The back tabs 34 are configured to mate with protrusions 36 on, or operably connected to, the storage module 32. For instance, in the embodiment illustrated by FIGS. 7a, 7b, and 7c, two back tabs 34 are arranged above the opening of the cavity 38 and one back tab 34 is positioned beneath the opening of the cavity 38. However, the number and positioning of the back tab(s) 34 may be varied in accordance with the positioning and number of protrusions 36 on the storage module 32. As shown, each back tab 34 may include a hole 40 that allows the back tab 34 to be slide over and/or around at least a portion of the mating protrusion 36. However, the back tabs 34 may also be configured to connect to the storage module 32 in a number of different other ways, including through the use of hook and loop material, snaps, buttons, and magnets, among others.

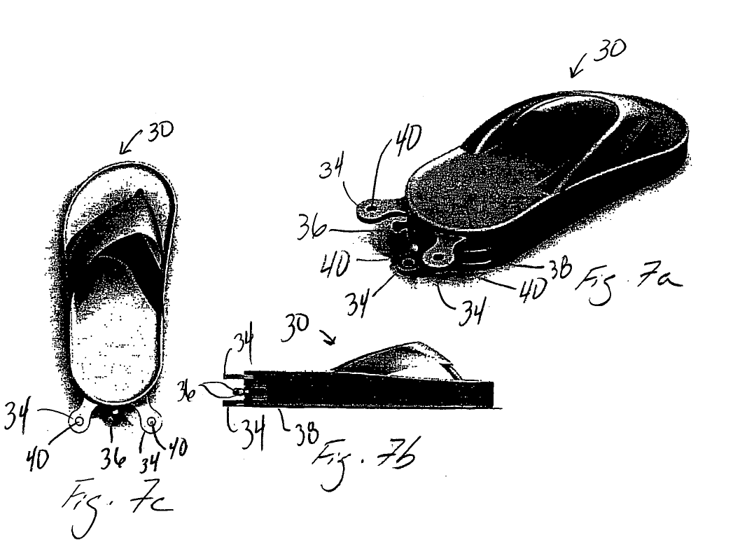

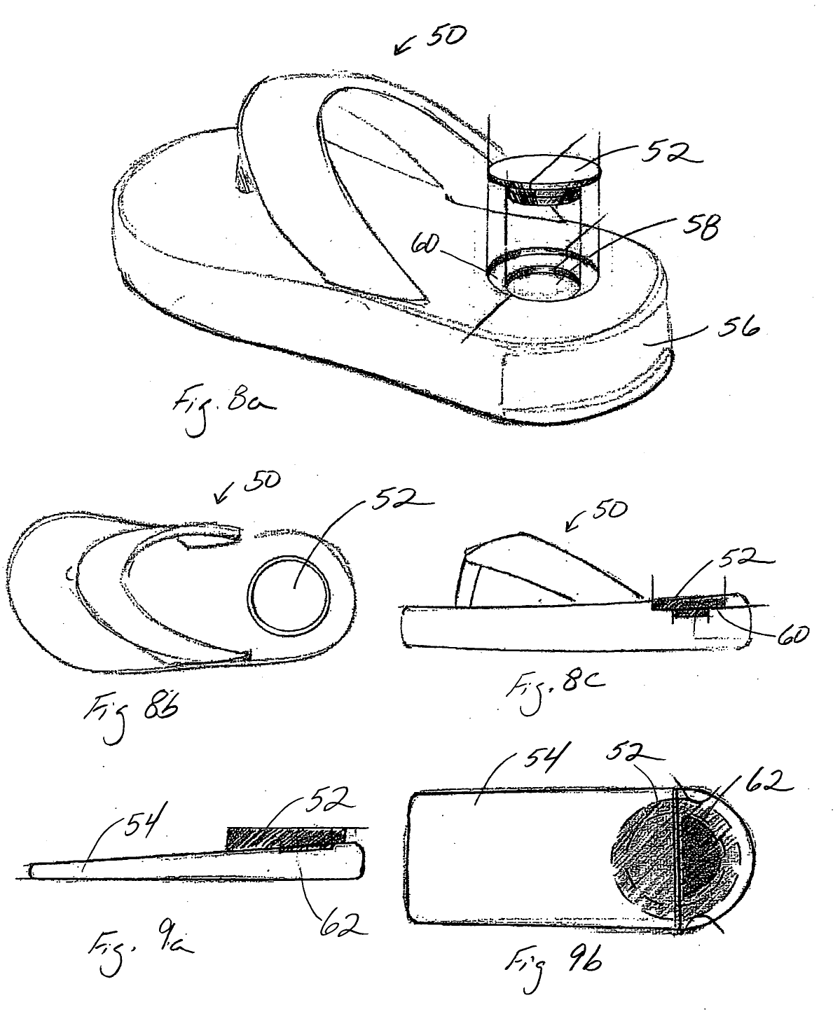

FIGS. 8a, 8b, and 8c illustrate a perspective, top, and side view, respectively, of a shoe 50 having a plug insert 52 that may assist in securing at least a portion of the storage module 54 within the cavity 56 according to one embodiment of the present invention. The plug insert 52 may be configured to fit into an orifice 58 that is in communication with at least a portion of the cavity 56. In the embodiment illustrated in FIGS. 8a, 8b, and 8c, the orifice 58 may include a shoulder 60 upon which at least a portion of the plug insert 52 may abut against when the plug insert 52 is positioned on the shoe 10.

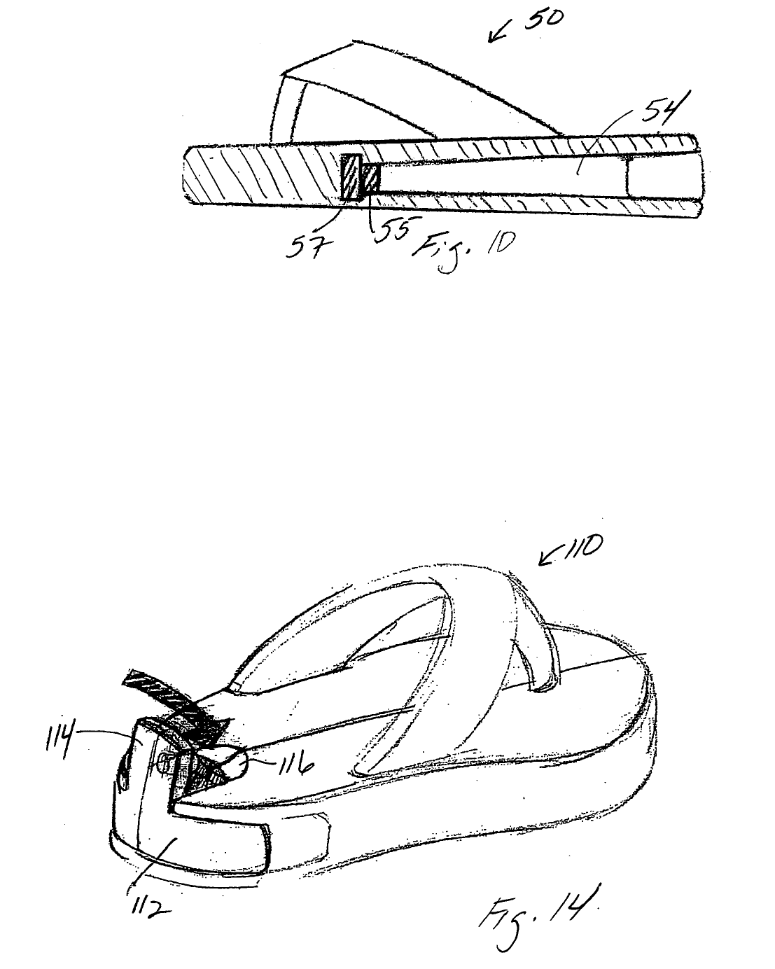

FIGS. 9a and 9b illustrate a side and bottom view, respectively, of a storage module 54 that is configured to mate with a plug insert 52 according to one embodiment of the present invention. In the illustrated embodiment, the plug insert 52 may include a lip portion 62 that maters with an indentation 64 on the storage module 54. For instance, both the lip portion 62 and the indentation 64 may have a semi-circular shape. In such an embodiment, the storage module 54 may be inserted into the cavity 56 until the indentation 64 is at a desired location relative to the orifice 58. The plug insert 52 may then be inserted into the orifice 58, with the lip portion 62 of the plug aligned to be received into the indentation 64 so that the plug insert 52 is securely attached to the storage module 54. Alternatively, the plug insert 52 may be positioned within the orifice 58 before the storage module 54 is inserted into the cavity 56. In such an operation, the storage module 54 may then continued to be inserted into the cavity 56 until the indentation 64 reaches, and connects with, the lip portion 62 of the plug insert 52.

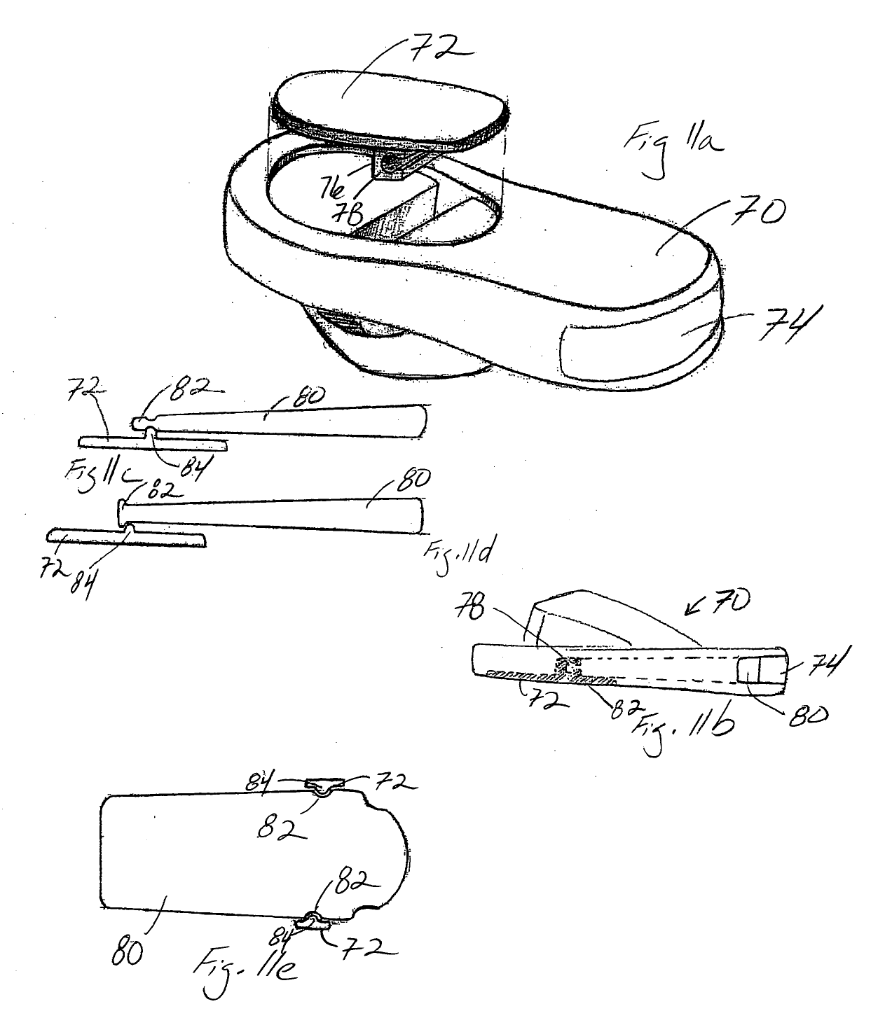

The connecting interaction between the plug insert 52 and the storage module 54 may take a variety of forms. For instance, as mentioned above, the plug insert 52 may include a lip portion 62 that mates with an indentation 64 of the storage module 54. Alternatively, the plug insert 52 may include a male thread portion that mates with the female threaded portion of the storage module 64. In another embodiment, both the plug insert 52 and storage module 54 may be operably connected to magnets so that a magnetic connection is created between the storage module 54 and the plug insert 52 that assists in securing the storage module 54 within the cavity 56. Alternatively, in the absence of a plug insert 54, at least one magnet may be embedded or inserted into, along, or against the cavity portion. For instance, as illustrated in FIG. 10, a portion of the front region of the storage module 54 may be connected to a magnet 55 which, when inserted into the shoe 50, interacts with a magnet 57 embedded in the vicinity of the front wall portion of the cavity 56.

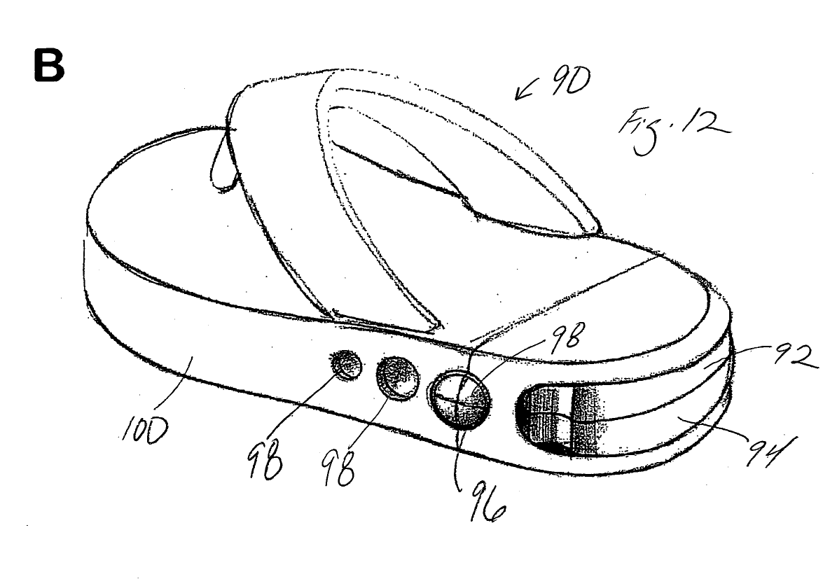

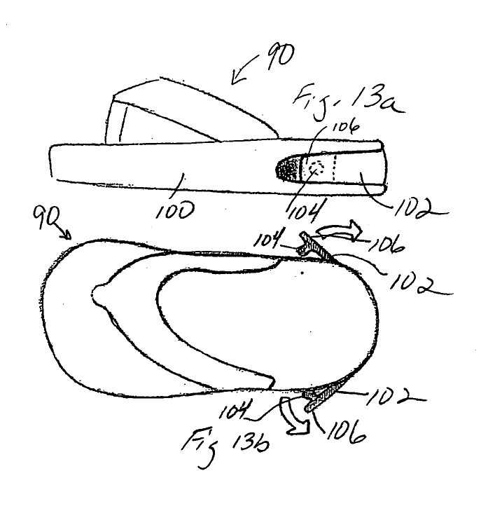

FIG. 11a illustrates a perspective view of a shoe 70 having a plug insert 72 configured to assist in retaining a storage module in the cavity 74 of a shoe 70 according to one embodiment of the present invention. The plug insert 72 may be permanently or removable connected to the shoe 70. In one embodiment, the plug insert 72 may include a lip 76 having a ridge or groove 78 that interacts with a portion of the storage module 80 to assist in securing the storage module 80 within the shoe 70. For instance, as illustrated in FIG. 11b, the front portion of the storage module 80 may have a tip region 82 that interacts with a groove 78 in the lip 76 to create a connection between the plug insert 72 and the storage module 80 that may assist in securing the storage module 80 within the cavity 74. However, the interlocking connection between the storage module 80 and the plug insert 72 may take on a number of different arrangements, as shown by way of example by the interactions between the recesses 84 in the storage module 80 and the ridge(s) 84 of the plug inserts 72 in FIGS. 11c, 11d, and 11e.

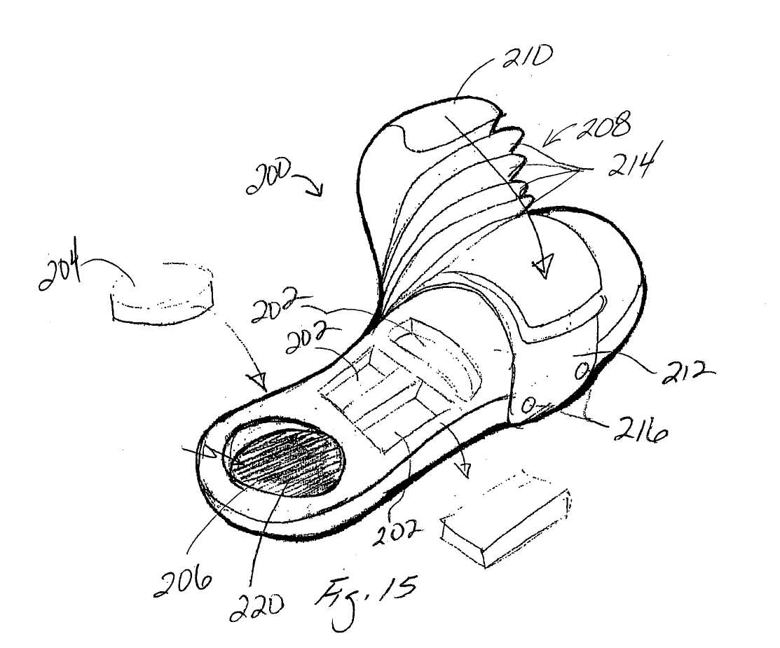

FIG. 12 illustrates a perspective view of a storage module 92 secured inside the cavity 94 of a shoe 90 through the use of at least one protrusion 96 on the storage module 92 interlocking with a mating aperture 98 in the shoe 90 according to one embodiment of the present invention. As illustrated, the shoe 90 may have a number of different apertures 98 along at least one side of the sole 100. The apertures 98 may all be of generally uniform size and shape or may have different shapes that correspond to the use of different storage modules 92. The interlocking attachment between the protrusion 96 and the aperture 98 may be created through a variety of different ways, including sizing the aperture 98 relative to the protrusion 96, the resiliency or flexibility of the material of the sole 100 or storage module 92, the size of the storage module 92 relative to the size of the cavity 94, or a combination thereof, among others. Further, the protrusions 96 and apertures 98 may be positioned at various positions along the storage module 92 and shoe 90, respectively, including along the front, top, bottom, or sides of the module 92 and shoe 90.

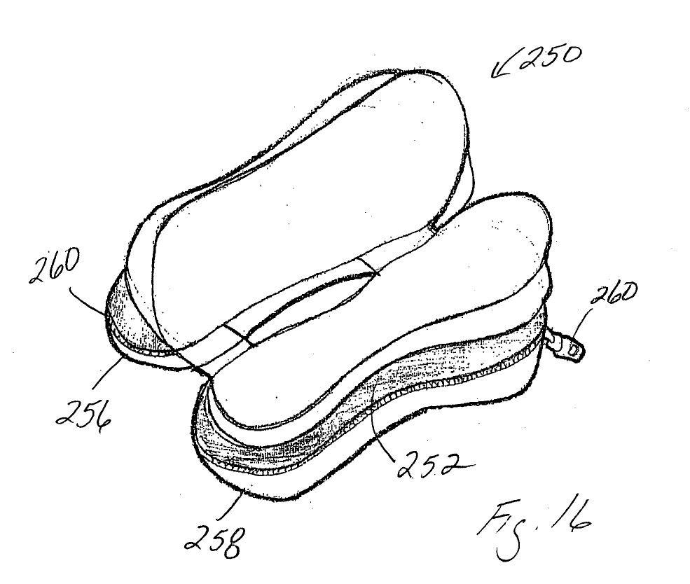

FIGS. 13a and 13b illustrate a side and top view of a storage module 92 secured inside the cavity 94 of a shoe 90 through the use of attachment straps 102 on the storage module 92 interlocking with the shoe 90 according to one embodiment of the present invention. The attachment straps 102 may be an integral part of the storage module, or may be operably attached to the storage module 92, such as through the use of hooks, loops, hook and loop material, stitching, and adhesives, among others. The distal end 106 of the attachment strap 102 may include a fastener that interlocks with a mating fastener on the shoe 90. For example, the distal end 106 may include a knob 104 that mates with one or more apertures 98 of along the sole 100 of the shoe. In another embodiment, the knobs 104 may pass through the apertures 98 and have a mating interlocking connection with a recess on another part of the storage module. In such an embodiment, the storage module is secured to the shoe 90 through the at least partial wrapping of the attachment strap 102 and/or knobs 104, around and through at least a part of the shoe 90.

FIG. 14 illustrates perspective view of a storage module 112 having a tab extension 114 that mates with a portion of a shoe 110 in accordance with one embodiment of the present invention. As illustrated, at least a portion of the storage module 112 fits within the cavity of the shoe 110. The storage module 112 may include an extension tab 114 that may be manipulated for engagement with at least a portion of the shoe 110 so as to assist in securing the storage module 112 within the cavity. For example, the tab extension 114 may be molded or formed as part of the storage module 112, and may be capable of being folded or bent over a portion of the shoe 110 so as to lock with, or abut against, at least a portion of the shoe 110. The shoe 110 may include a slot 116 that is configured to mate with the extension tab 114 when the extension tab 114 is folded or bent so as to assist in maintaining the storage module 112 within the cavity. Although FIG. 14 illustrates the use of one extension tab 114, the storage module 112 may be operably connected to multiple extension tabs 114 that may be positioned along different positions along the storage module 112.

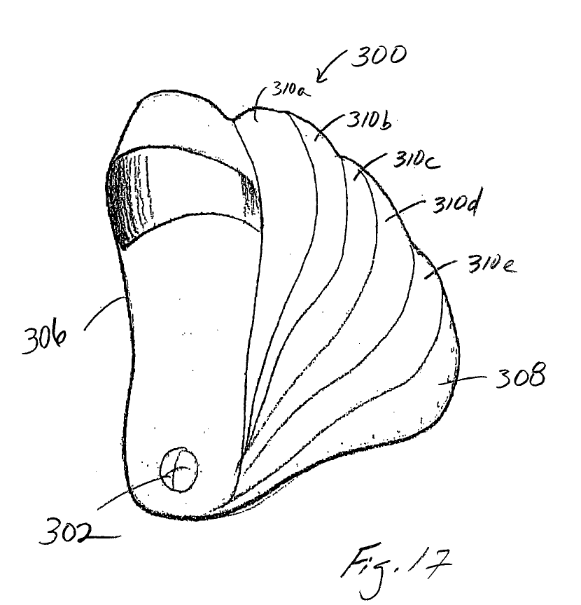

FIG. 15 illustrates perspective view of a shoe 200 having a first cavity 202, a second cavity 206, and a strap section 208 containing at cover 210, a bottom portion 212, and at least one page of literature 214 there-between. The number of first and second cavities 202, 206 and their configurations may vary depending upon the desired application. For instance, multiple first sections may be configured to receive the insertion of storage modules or items that may be used in connection with the literature 214, such as stamps 218, among other things. The second cavity 206 may also be configured for use in connection with the materials contained within the first cavity 202. For instance, the second cavity 206 may contain an inkpad 220 that is used in connection with the stamps 218 that are stored in the first cavity 202, and which may be used in connection with the literature 208. The literature 208 may be retained between a cover 210 and a bottom portion 212. As least a portion of the cover 210 may be configured to mate with the bottom portion 212 so as to close access to the literature 208, such as through a locking interaction with tabs 216 that are positioned on the bottom portion 212.

FIG. 16 illustrates a perspective view of a shoe 250 having a hollow inner region 252 that is configured for the removable insertion of a storage module 254 according to one embodiment of the present invention. As illustrated, the shoe 250 may include an upper portion 256 and a lower portion 258 that may be at least partially separated from each other. In such an embodiment, the upper and lower portions 256, 258 may be joined together through the use of a variety of fasteners, including, but not limited to a zipper 260 in addition to the various other types of fasteners previously described herein. The storage module 254 may be configured to be inserted into the inner region 252. In one embodiment of the present invention, the storage module may be configured to assist in providing support and/or comfort to the foot of the individual wearing the shoe 250. The storage module 254 may also be used to store a variety of other different contents without the use of a storage module 254. Further, these other contents, such as a book, may also be configured to assist in providing support and/or comfort to the foot of the individual wearing the shoe 250.

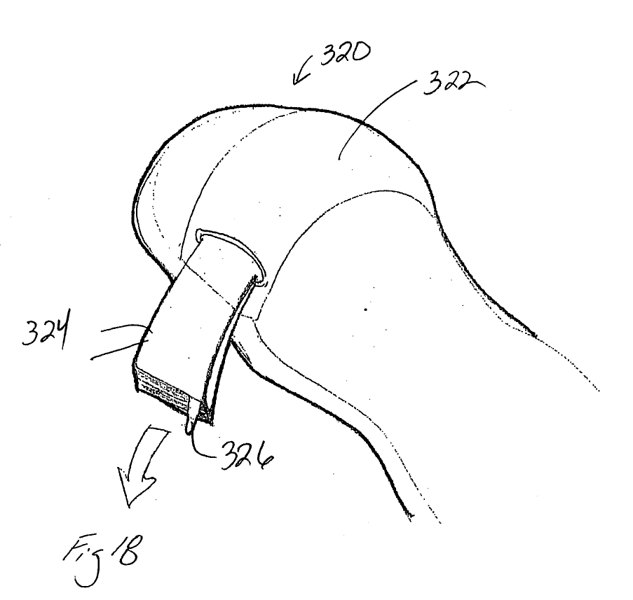

FIG. 17 illustrates top view of a shoe 300 having at least one fastener 302 and a sole that includes a top portion 306, a bottom portion 308, and a middle section 304 having multiple layers 310a-e that may be separated to form the pages of literature according to one embodiment of the present invention. As shown, the fastener 302 may be released or loosed so that one or more layers 310a-e of the middle section may be at least partially separated from the top portion 306 and/or bottom portion 308 of the sole. By at least partially separating the one or more layers 310a-e of the middle section, the top portion 306 and/or bottom portion 308, information, such portions of a story, printed on each of layers 310a-e may be viewed or read. In the embodiment illustrated in FIG. 14, the layers may be pivoted about one fastener 302. However, in other embodiments, the individual layers 310a-e may be completely removed, with or without the top and/or bottom portions 306, 308, from the remainder of the shoe 300. Additionally, multiple fasteners may us used to operably secure the top portion 306, a bottom portion 308, and a middle section 304 together so as to form the shoe 300.

FIG. 18 illustrates a perspective view of a shoe in the form of a sandal 320 having a cavity within the strap portion 322 of the sandal 320 according to one embodiment of the present invention. The cavity in the sandal 320 may be configured to receive the removable insertion of a storage module or literature 324, which may also include a tab 326 that assists in the ability to grasp the storage module or literature 324 and pull the storage module or literature 324 out from the cavity. Although FIG. 18 is illustrated in the form of a sandal, the cavity exemplified by FIG. 18 may also be used with a variety of other shoes. For instance, the cavity may be located in the tongue portion of other shoes, such as dress shoes and athletic shoes.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed:

1. A storage apparatus comprising:
a. a shoe having at least one cavity, the at least one cavity having an inner portion, the inner portion configured to provide an at least partially hollow section within the shoe; and
b. a storage module, at least a portion of the storage module configured for removable insertion into the inner portion of the at least one cavity, the storage module including at least one inner region.

2. The storage apparatus of claim 1 wherein storage module includes at least one protrusion, the protrusion configured to mate with at least one aperture along the shoe so as to secure at least a portion of the storage module in the cavity.

3. The apparatus of claim 1 wherein the shoe includes a heel region, the heel region being operably connected to a back tab, the back tab configured to mate with a protrusion on the storage module so as to secure at least a portion of the storage module in the cavity.

4. The apparatus of claim 1 wherein the shoe is operably connected to a plug insert, the plug insert having a lip that is configured to mate with an indentation on the storage module so as to secure at least a portion of the storage module in the cavity.

5. The apparatus of claim 1 wherein a first is embedded in the shoe, the first positioned to form a magnetic connection with a second magnet located on the storage module so as to secure at least a portion of the storage module in the cavity.

6. The apparatus of claim 1 wherein the storage module is operable connected to at least one attachment strap, the at least one attachment strap including a distal end having a knob, and wherein the shoe includes a sole having at least one aperture, the knob being configured to mate with the at least one aperture to secure the storage module within the cavity.

7. The apparatus of claim 1 wherein the storage module is operable connected to at least one attachment strap, the at least one attachment strap including a distal end having a knob, and wherein the shoe includes a sole having at least one aperture, the knob being configured to pass through at least a portion of the at least one aperture and mate with a recess along the storage module.

8. The invention of claim 1 wherein the storage module includes a first section, a second section, and a seal, the first section and the second section being configured for a locking engagement between each other, the seal configured to create a tight connection between the first and second sections.

9. The invention of claim 1 wherein the shoe includes an upper portion and a lower portion, the upper portion configured to be at least temporarily at least partially separated from the lower portion, the cavity being positioned between the upper portion and lower portion, the storage module configured to be placed within the cavity and to provide support to the foot of the individual wearing the shoe.

10. The invention of claim 1 wherein the cavity is positioned in a portion of the shoe located above the upper portion of the foot.

11. A storage apparatus comprising:
a. a shoe having at least one cavity, the at least one cavity having an inner portion, the inner portion configured to provide an at least partially hollow section within the shoe; and
b. a storage module, storage module includes a first section, a second section, and a seal, the first section and the second section being configured for a locking engagement between each other, the seal configured to create a tight connection between the first and second sections, at least a portion of the storage module configured for removable insertion into the inner portion of the at least one cavity, the storage module including at least one inner region.

12. The storage apparatus of claim 11 wherein storage module includes at least one protrusion, the protrusion configured to mate with at least one aperture along the shoe so as to secure at least a portion of the storage module in the cavity.

13. The apparatus of claim 11 wherein the shoe includes a heel region, the heel region being operably connected to a back tab, the back tab configured to mate with a protrusion on the storage module so as to secure at least a portion of the storage module in the cavity.

14. The apparatus of claim 11 wherein the shoe is operably connected to a plug insert, the plug insert having a lip that is configured to mate with an indentation on the storage module so as to secure at least a portion of the storage module in the cavity.

15. The apparatus of claim 11 wherein a first is embedded in the shoe, the first positioned to form a magnetic connection with a second magnet located on the storage module so as to secure at least a portion of the storage module in the cavity.

16. The apparatus of claim 11 wherein the storage module is operable connected to at least one attachment strap, the at least one attachment strap including a distal end having a knob, and wherein the shoe includes a sole having at least one aperture, the knob being configured to mate with the at least one aperture to secure the storage module within the cavity.

17. The apparatus of claim 1 wherein the storage module is operable connected to at least one attachment strap, the at least one attachment strap including a distal end having a knob, and wherein the shoe includes a sole having at least one aperture, the knob being configured to pass through at least a portion of the at least one aperture and mate with a recess along the storage module.

18. The apparatus of claim 11 wherein the storage module includes a tab extension, the tab extension configured to be manipulated to abut against at least a portion of the shoe so as to secure at least a portion of the storage module in the cavity.

19. A storage apparatus comprising:
a. a shoe having at least one cavity, the at least one cavity having an inner portion, the inner portion configured to provide an at least partially hollow section within the shoe; and
b. a storage module, storage module includes a first section, a second section, and a seal, the first section and the second section being configured for a locking engagement between each other, the seal configured to create a tight connection between the first and second sections, at least a portion of the storage module configured for removable insertion into the inner portion of the at least one cavity, the storage module including at least one inner region, wherein storage module includes at least one protrusion, the protrusion configured to mate with at least one aperture along the shoe so as to secure at least a portion of the storage module in the cavity.

20. The storage apparatus of claim 19 wherein the aperture of the storage module is attached to a back tab that mates with at least a portion of a protrusion located on the rear portion of the storage module.
